(19) United States
(12) Patent Application Publication
(10) Pub. No.: US 2021/0086304 A1
(43) Pub. Date: Mar. 25, 2021

(54) GRADIENT WETTABILITY TOOL, FABRICATION METHOD AND APPLICATION THEREOF

(71) Applicant: Nanjing University of Aeronautics and Astronautics, Nanjing (CN)

(72) Inventors: Xiuqing HAO, Nanjing (CN); Pengcheng SUN, Nanjing (CN); Hanlong LI, Nanjing (CN); Yusheng NIU, Nanjing (CN); Liang LI, Nanjing (CN); Ning HE, Nanjing (CN)

(21) Appl. No.: 16/737,092

(22) Filed: Jan. 8, 2020

(30) Foreign Application Priority Data
Sep. 25, 2019 (CN) 201910909892. X

(51) Int. Cl. B23K 26/361; B23K 26/364

(52) U.S. Cl. CPC B23K 26/361; B23K 26/40; B23K 26/364

(57) ABSTRACT

A gradient wettability tool and a fabrication process thereof are disclosed, the gradient wettability tool comprising a tool body and a lyophobic layer arranged on a surface of the tool body. A lyophilic micro-texture is arranged on a part of a surface of the lyophobic layer, and comprises main trapezoid grooves, a wide end of which is arranged in a tool-chip interface of the tool with a distance of 1 to 200 μm from a midpoint of the wide end of the groove to a cutting edge of the tool, and inward-radiated trapezoid microgrooves, a wide end of which is arranged to be connected to a narrow end of the main trapezoid groove. The gradient wettability tool allows directional transport of a cutting fluid and reduction of friction forces at tool-workpiece and tool-chip interfaces, and thus provides wear reduction.

### RELATED APPLICATION

The present application claims priority to Chinese Patent Application 201910909892.X, filed on Sep. 25, 2019, which is incorporated herein by reference.

### TECHNICAL FIELD

The present invention relates to the technical field of cutting tools for mechanical processing, and in particular, to a gradient wettability tool, a fabrication method and an application thereof.

### BACKGROUND

With increasing requirements for mechanical strength, corrosion resistant, and hardness of materials, hard-to-machine materials account for more than 40% of a total amount of workpiece materials today. During the cutting process of the hard-to-machine materials, tool-chip interfaces are mostly in a close contact state, and an exterior cutting fluid merely enters an edge region of the friction pair contact interface simply by means of the capillary penetration, etc., which may cause the cutting fluid to fail to exhibit its lubrication effect. This may lead to problems such as quick wear of cutting tools, bad surface quality, low processing accuracy and low processing efficiency, which greatly limit an application range of the hard-to-machine materials. In view of the above, development of a high-performance cutting tool for the hard-to-machine materials is currently an issue to be urgently solved.

### SUMMARY

Objectives of the present invention are to provide a gradient wettability tool, a fabrication method and an application thereof. The tool according to the present invention allows directional transport of a cutting fluid and reduction of friction forces at tool-workpiece and tool-chip interfaces, and thus provides wear reduction.

To achieve the above objectives, embodiments of the present invention provide the following technical solutions.

A gradient wettability tool is provided, including a tool body and a lyophobic layer arranged on a surface of the tool body, where a lyophilic micro-texture is arranged on a part of a surface of the lyophobic layer, and the lyophilic micro-texture includes main trapezoid grooves, a wide end of which is arranged in a tool-chip interface of the tool with a distance of 1 to 200 μm from a midpoint of the wide end of the groove to a cutting edge of the tool, and inward-radiated trapezoid microgrooves, a wide end of which is arranged to be connected to a narrow end of the main trapezoid groove.

In a preferred embodiment of the invention, an area of the lyophilic micro-texture may account for 5 to 50% of a total area of the lyophobic layer.

In a preferred embodiment of the invention, an angle between the single inward-radiated trapezoid microgroove and the single main trapezoid groove may be less than or equal to 90 degrees.

In a preferred embodiment of the invention, the main trapezoid grooves may be arranged such that any two grooves may be spaced 2 μm to 6 mm apart from each other.

In a preferred embodiment of the invention, the single main trapezoid groove may have a wedge angle of 1 to 10 degrees, a depth of 1 to 100 μm, a length of 0.1 to 10 mm, and a width of 1 μm to 3 mm Preferably, an angle between the main trapezoid groove and an outflow direction of the chips may be 5 to 175 degrees.

In a preferred embodiment of the invention, the inward-radiated trapezoid microgroove may have a wedge angle of 1 to 10 degrees, a depth of 1 to 100 μm, a length of 0.1 to 5 mm, and a width of 1 μm to 3 mm

Embodiments of the present invention further provide a fabrication process of the tool as mentioned above, including steps of:

fabricating a lyophobic layer on a surface of a tool body, and forming a lyophilic micro-texture, including main trapezoid grooves and inward-radiated trapezoid microgrooves, on a part of a surface of the lyophilic layer to obtain the tool.

In a preferred embodiment of the invention, a method for forming the lyophilic micro-texture may include a laser processing method, and operating conditions of the laser processing method may include: a laser wavelength of 1060 nm, and a laser power of 5 to 30W.

The embodiments of the invention further provide use of the tool as mentioned above or of a tool fabricated by the process as mentioned above in a high-speed cutting process or a hard-to-machine material cutting process.

The embodiments of the present invention provide a gradient wettability tool, including a tool body and a lyophobic layer arranged on a surface of the tool body, where a lyophilic micro-texture is arranged on a part of a surface of the lyophobic layer, and the lyophilic micro-texture includes main trapezoid grooves, a wide end of which is arranged in a tool-chip interface of the tool with a distance of 1 to 200 μm from a midpoint of the wide end of the groove to a cutting edge of the tool, and inward-radiated trapezoid microgrooves, a wide end of which is arranged to be connected to a narrow end of the main trapezoid grooves. According to the present invention, the lyophobic layer is in a super-lyophobic state, and the lyophilic micro-texture formed by the main trapezoid grooves and the inward-radiated trapezoid microgrooves, the wide end of which is arranged to be connected to the narrow end area of the main trapezoid groove, are in a super- lyophilic state. In practice, the cutting fluid is allowed to be quickly and automatically collected into the main trapezoid grooves under the combined action of the inward-radiated trapezoid microgrooves and the surface tension of the cutting fluid droplets, and then be directionally transported to the tool-chip interfaces under the combined action of the main trapezoid grooves and the surface tension of the cutting fluid droplets. Therefore, friction forces at tool-workpiece and tool-chip interfaces can be reduced, and wear reduction of the cutting tool can thus be achieved. The tool of the present invention can be widely applied to high-speed cutting processes and the cutting processes of hard-to-machine materials, and can provide improvement in durability, machining quality and machining accuracy.

In further embodiments of the present invention, dimensions of the inward-radiated trapezoid microgrooves and the main trapezoid grooves may be adjusted so as to facilitate transport velocity of the cutting fluid between the cutting fluid receiving area and the cutting edge and thus actively regulate the lubrication state of the cutting area.

### BRIEF DESCRIPTION OF THE DRAWINGS

FIG. 1 is a schematic diagram showing a structure of a main trapezoid groove and an inward-radiated trapezoid microgroove in a surface of a tool according to an embodiment of the present invention.

FIG. 2 is a schematic diagram illustrating the positional relationship between the single main trapezoid groove and the inward-radiated trapezoid microgrooves in the surface of the tool according to an embodiment of the present invention.

FIG. 3 is a schematic diagram showing the principle of an improvement of a lubrication state of the surface of the tool according to an embodiment of the present invention.

FIG. 4 is a schematic flow chart of an embodiment of a process for fabricating the tool according to the present invention.

FIG. 5 is a schematic diagram showing transport of a cutting fluid added onto the tool according to an embodiment of the present invention.

### DETAILED DESCRIPTION

The present invention provides a gradient wettability tool, including a tool body and a lyophobic layer arranged on a surface of the tool body. A lyophilic micro-texture is arranged on a part of a surface of the lyophobic layer. The lyophilic micro-texture includes main trapezoid grooves and inward-radiated trapezoid microgrooves. A wide end of the single main trapezoid groove is arranged in a tool-chip interface of the tool with a distance of 1 to 200 um from a midpoint of the wide end of the groove to a cutting edge of the tool. A wide end of the single inward-radiated trapezoid groove is arranged to be connected to a narrow end area of the single main trapezoid groove.

According to the present invention, the tool includes a tool body. The shape and material of the tool body are not particularly limited, but the tool body may be any cutting tool known in the art. In an embodiment of the present invention, the tool body may be made from, for example, cemented carbide YT15 or YG8.

According to the present invention, the tool includes a lyophobic layer arranged on a surface of the tool body. In an embodiment of the present invention, the lyophobic layer may be preferably comprised of microstructure arrays, and a shape of the microstructure in the arrays preferably includes one or more of a groove, a square pit, a triangle and an ellipse, more preferably the groove. A size of the microstructure, an array pitch and a number of the arrays are not particularly limited, but may be those known in the art. In an embodiment of the present invention, in particular, the arrays of the microstructure may be designed according to Chinese patent application CN107283062 (Method for Fabricating Lyophobic Surface via Under-liquid Laser Machining)

According to the present invention, the tool includes a lyophilic micro-texture which is arranged on a part of a surface of the lyophobic layer. In an embodiment of the present invention, an area of the lyophilic micro-texture may preferably account for 5 to 50% of a total area of the lyophobic layer, more preferably 10 to 50%, and further preferably 20 to 50%. According to the present invention, the lyophilic micro-texture includes main trapezoid grooves, a wide end of which is arranged in a tool-chip interface of the tool with a distance of 1 to 200 μm, preferably 1 to 100 μm, and more preferably 20 to 50 μm, from a midpoint of the wide end of the groove to a cutting edge of the tool, and inward-radiated trapezoid microgrooves, a wide end of which is connected to a narrow end area of the main trapezoid grooves. In an embodiment of the present invention, the inward-radiated trapezoid microgrooves may be arranged in a cutting fluid spraying area, which may be connected to the tool-chip interface through the main trapezoid groove to guarantee that a cutting fluid can be directionally transported to the tool-chip interface. Therefore, friction forces at a tool-workpiece interface and the tool-chip interface can be reduced, and friction and wear reduction of the cutting tool are guaranteed.

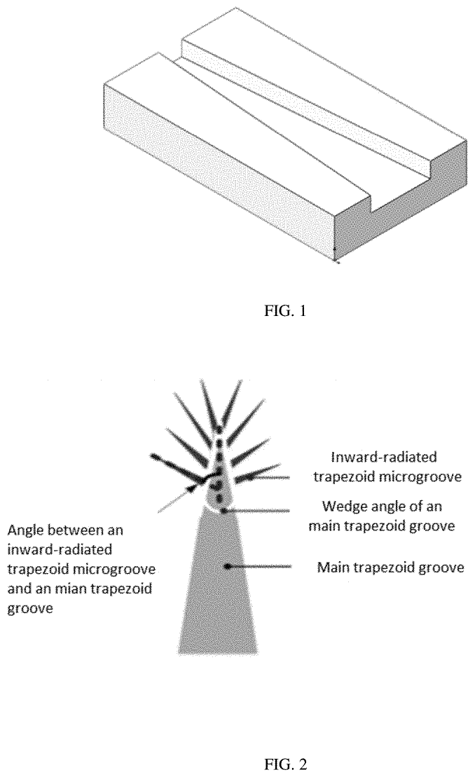

In an embodiment of the present invention, both the main trapezoid groove and the inward- radiated trapezoid microgroove have a trapezoid shape, as shown in FIG. 1 (FIG. 1 is provided to merely illustrate the shape of the main trapezoid groove and the inward-radiated trapezoid microgroove, but not to limit their sizes). In an embodiment of the present invention, ‘inward radiation’ of the inward-radiated trapezoid microgroove refers to a connection of the wide end of the microgroove to the narrow end area of the main trapezoid groove. During use of the tool, the cutting fluid is allowed to be quickly and automatically collected into the main trapezoid grooves under the combined action of the microgrooves and surface tension of cutting fluid droplets.

In an embodiment of the present invention, an angle between the single inward-radiated trapezoid microgroove and the single main trapezoid groove may be preferably less than or equal to 90 degrees, more preferably 20 to 60 degrees. In an embodiment of the present invention, in particular, the angle between the single inward-radiated trapezoid microgroove and the single main trapezoid groove is an angle between center lines of the two grooves, as shown in FIG. 2.

In an embodiment of the present invention, the main trapezoid grooves may be preferably arranged such that any two grooves may be spaced 2 μm to 6 mm apart from each other. In an embodiment of the present invention, a wedge angle of the single main trapezoid groove may be in a range of preferably 1 to 10 degrees, more preferably 4 to 8 degrees. In particular, the wedge angle of the main trapezoid groove may be an angle between two legs of a corresponding trapezoid of the main trapezoid groove, as shown in FIG. 2. A depth of the main trapezoid groove may be in a range of preferably 1 to 100 μm, more preferably 10 to 50 μm. A length of the main trapezoid groove may be in a range of preferably 0.2 to 9 mm, and more preferably 1 to 8 mm. A width of the main trapezoid groove, which is in particular defined by a length of the narrow end of the main trapezoid groove, may be in a range of preferably 1 μm to 3 mm, more preferably 0.1 to 1 mm. An angle between the single main trapezoid groove and an outflow direction of the chips may be preferably 5 to 175 degrees, more preferably 30 to 60 degrees or 120 to 150 degrees.

In an embodiment of the present invention, a length of the narrow end area of the main trapezoid groove, along the length thereof, may be preferably not greater than ⅓ of a total length of the main trapezoid groove to facilitate transport of the cutting fluid between a cutting fluid receiving area and the cutting edge.

In an embodiment of the present invention, a wedge angle of the single inward-radiated trapezoid microgroove, which may be in particular defined by an angle between two legs of a corresponding trapezoid of the inward-radiated trapezoid microgroove, may be in a range of preferably 1 to 10 degrees, more preferably 4 to 8 degrees. A depth of the inward-radiated trapezoid microgroove may be in a range of preferably 1 to 100 μm, more preferably 10 to 50 μm. A length of the microgroove may be in a range of preferably 0.2 to 5 mm, more preferably 0.5 to 3 mm. A width of the microgroove, which may be in particular defined by a length of a narrow end of the microgroove, may be in a range of preferably 1 μm to 0.5 mm, more preferably 0.1 to 0.5 mm. In an embodiment of the present invention, a number of the inward-radiated trapezoid microgrooves connected to the single main trapezoid groove may be preferably 5 to 30, more preferably 15 to 30.

In an embodiment of the present invention, sizes (in particular, the length and the width) of the inward-radiated trapezoid microgroove may be preferably less than or equal to those of the main trapezoid groove, and the sizes of the microgroove may be more preferably less than those of the main trapezoid groove. In an embodiment of the present invention, when the main trapezoid groove is 9 mm long and 1 mm wide, the inward-radiated trapezoid microgroove may be 3 mm long and 0.5 mm wide. In another embodiment, when the main trapezoid groove is 8 mm long and 0.5 mm wide, the inward-radiated trapezoid microgroove may be 2 mm long and 0.2 mm wide.

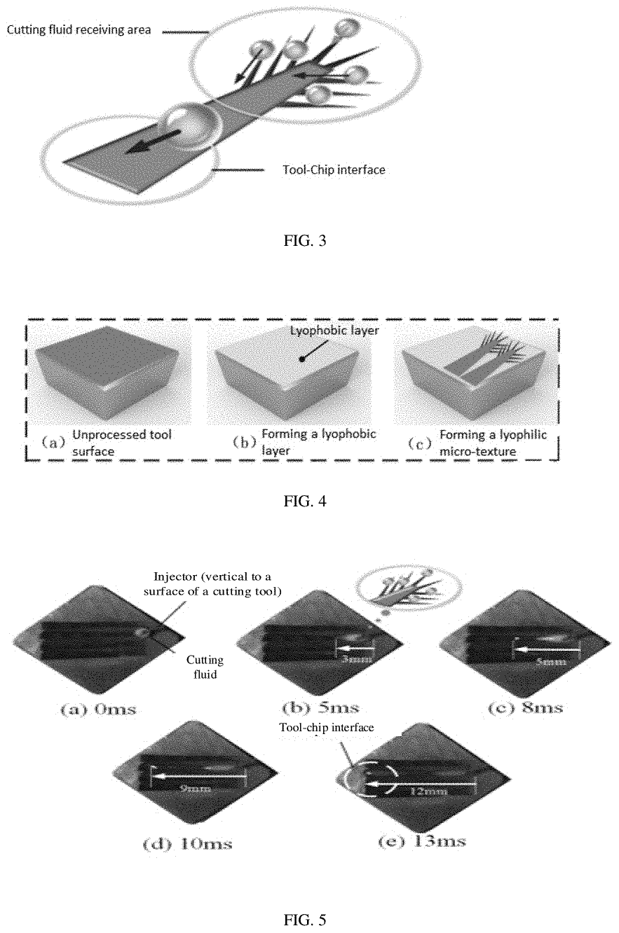

FIG. 3 is a schematic diagram which shows the principle of an improvement of a lubrication state of the surface of the tool according to the present invention. Both the inward-radiated trapezoid microgroove and the main trapezoid groove are trapezoid-shaped. In the use of the tool, the cutting fluid in the trapezoid-shaped grooves generates Laplace pressure under the action of the surface tension, and thus actively moves from the narrow ends of the trapezoid grooves to the wide ends thereof. Therefore, the multiple inward-radiated trapezoid microstructures collect the cutting fluid like the root of a tree, and then the cutting fluid is collected into the narrow end of the main trapezoid groove. Similarly, the cutting fluid collected in the main trapezoid groove is transported from its narrow end to its wide end under the action of the Laplace pressure and a capillary force. An area, at which the wide end of the main trapezoid groove is located, may be just the tool-chip interface, so that a large amount of the cutting fluid can be actively and directionally transported to the tool-chip interface to form a lubricate film so as to make the tool- workpiece and tool-chip interfaces lubricated well and reduce friction forces at the interfaces. Therefore, the tool of the present invention provides high efficiency of collecting the cutting fluid by the lyophilic micro-texture, and allows directional transport of the cutting fluid.

The present invention further provides a fabrication process of the gradient wettability tool as mentioned above, including the following steps:

first, fabricating a lyophobic layer on a surface of a tool body, then forming a lyophilic micro-texture including main trapezoid grooves and inward-radiated trapezoid microgrooves on a part of a surface of the lyophobic layer to obtain the tool.

FIG. 4 is a schematic flow chart of an embodiment of the process for fabricating the gradient wettability tool according to the present invention, where the microstructure arrays on the lyophobic layer are not shown.

According to the present invention, a lyophobic layer is fabricated on a surface of a tool body. A method for fabricating the lyophobic layer is not particularly limited, but may be any one known in the art. In particular, the lyophobic layer may be fabricated on the surface of the tool body by the method disclosed in Chinese patent application CN107283062 (Method for Fabricating Lyophobic Surface via Under-liquid Laser Machining) or Chinese patent application CN105234645 (Method for Fabricating Lyophilic-lyophobic Combined Textured Tool Surface), preferably by the laser liquid-phase processing method disclosed in CN107283062 so as to obtain a stable and wear-resistant lyophobic layer, which is less likely to fail due to wear during the cutting process. In an embodiment of the present invention, operating conditions of the laser liquid-phase processing method may preferably include: a laser pulse energy of 2 to 1000 mJ, a pulse width of 50 fs to 24 ps and a repetition frequency of 10 to 2000 Hz, and more preferably include: a laser pulse energy of 20 to 300 mJ, a pulse width of 75 fs to 15 ps and a repetition frequency of 100 to 1000 Hz. In an embodiment of the present invention, the method for fabricating the lyophobic layer by utilizing the laser liquid-phase processing method preferably includes the following steps:

immersing the tool body into a fluorinated solution, such that the surface of the tool body may be positioned at a distance of 1 to 2 mm from the surface of the fluorinated solution; processing the surface of the tool body by laser to obtain microstructure arrays; blowing the tool body dry with high purity nitrogen and placing the dried tool body in a heat-retaining furnace at a temperature of 140 to 160° C. for 30 to 90 min to completely remove the solvent on surfaces of the tool; and cooling the tool naturally down to room temperature to obtain the lyophobic layer on the surface of the tool body.

In an embodiment of the present invention, the solute in the fluorinated solution may preferably include fluoroalkyl silane F1060 (CFH₂CH₂-Si(OC₂H₅)₃), trifluorosilane or fluoroacrylate copolymer, more preferably the fluoroalkyl silane F1060. The solvent may preferably include an alcohol solvent or methylbenzene, and the alcohol solvent may preferably include anhydrous ethanol or ethylene glycol. The fluorinated solution may preferably have a solute concentration of 0.4 to 2% w/w, more preferably 0.8 to 1.5% w/w.

According to the present invention, after fabrication of the lyophobic layer, a lyophilic micro-texture including main trapezoid grooves and inward-radiated trapezoid microgrooves is formed on a part of a surface of the lyophobic layer to obtain the gradient wettability tool. The method for forming the lyophilic micro-texture is not particularly limited as long as the required lyophilic micro-texture can be obtained. In an embodiment of the present invention, the method for forming the lyophilic micro-texture may preferably include a laser processing method, in which the laser with a wavelength of 1060 nm and a power of 5 W may be preferred.

In an embodiment of the present invention, after the lyophilic micro-texture is obtained, the tool may be preferably ultrasonically cleaned. In a further embodiment of the present invention, the tool may be preferably ultrasonically cleaned in acetone for 10 to 20 min using a KQ2200B type ultrasonic cleaner.

The embodiments of the present invention provide use of the gradient wettability tool as mentioned above or of a gradient wettability tool prepared by the process as mentioned above in a high-speed cutting process or a hard-to-machine material cutting process. The high-speed cutting process or the hard-to-cut material cutting process may be any one known in the art and is not particular limited.

The present invention will be detailed in connection with the following examples of embodiments of the invention. It should be clarified that, embodiments described are only a part of embodiments of the present invention, and are not all embodiments thereof. All other embodiments obtained by those skilled in the art based on the embodiments of the present invention without creative efforts shall fall within the scope of the claimed invention.

### EXAMPLE 1

A solution 1.5% by weight of fluoroalkyl silane F1060 (CFH₂CH₂-Si(OC₂H₅)₃) was prepared by using toluene as a solvent;

A tool body made from cemented carbide YT15 was immersed into the solution at a distance of about 1 mm from the surface of the solution. A surface of the cutting tool body was scanned and processed by a laser utilizing a laser liquid-phase processing method at a scanning interval of about 0.01 mm The tool body was blown dry using high-purity nitrogen and was placed in a heat-retaining furnace at 150° C. for 45 min to completely remove the toluene on surfaces of the tool. Then the tool was naturally cooled down to room temperature to obtain a lyophobic layer on the surface of the tool body. Operating conditions of the laser liquid-phase processing method included: a femtosecond laser pulse energy of 20 mJ, a pulse width of 75 fs and a repetition frequency of 1000 Hz.

A part of a surface of the lyophobic layer was processed by utilizing an optical fiber laser marking machine to obtain a lyophilic micro-texture. Then, the tool was ultrasonically cleaned in acetone for 15 min by a KQ2200B type ultrasonic cleaner to obtain the gradient wettability tool. Operating parameters of the optical fiber laser marking machine included: a laser wavelength of 1060 nm, and a laser power of 5 W. An area of the lyophilic micro-texture accounted for 50% of a total area of the lyophobic layer. The lyophilic micro-texture included main trapezoid grooves, a wide end of which was arranged in a tool-chip interface of the tool with a distance of 20 μm from a midpoint of the wide end of the groove to a cutting edge of the tool, and inward-radiated trapezoid microgrooves, a wide end of which was connected to a narrow end of the main trapezoid groove. The main trapezoid grooves were arranged with a pitch of 1 mm. A wedge angle of the single main trapezoid groove was 4 degrees. A depth of the single main trapezoid groove was 20 μm. A length was 9 mm, and a length of a narrow end of the main trapezoid groove was 3 mm. A width was 1 mm, and an angle between the single main trapezoid groove and an outflow direction of the chips was 45 degrees. A wedge angle of the inward-radiated trapezoid microgroove was 4 degrees. A depth was 20 μm. A length was 3 mm. A width was 0.5 mm. An angle between the inward-radiated trapezoid microgroove and the main trapezoid groove was 20 degrees. There were 20 inward-radiated trapezoid microgrooves connected to the single main trapezoid groove.

### EXAMPLE 2

A solution 0.8% by weight of fluoroalkyl silane F1060 (CFH₂CH₂-Si(OC₂H₅)₃) was prepared by using toluene as a solvent;

A tool body made from cemented carbide YG8 was immersed into the solution at a distance of about 1 mm from the surface of the solution. A surface of the cutting tool body was scanned and processed by a laser utilizing a laser liquid-phase processing method at a scanning interval of about 0.02 mm The tool body was blown dry using high-purity nitrogen and was placed in a heat-retaining furnace at 150° C. for 60 min to completely remove the toluene on surfaces of the tool. Then the tool was naturally cooled down to room temperature to obtain a lyophobic layer on the surface of the tool body. Operating conditions of the laser liquid-phase processing method included: a femtosecond laser pulse energy of 20 mJ, a pulse width of 75 fs and a repetition frequency of 1000 Hz.

A part of a surface of the lyophobic layer was processed by utilizing an optical fiber laser marking machine to obtain a lyophilic micro-texture. Then, the tool was ultrasonically cleaned in acetone for 15 min by a KQ2200B type ultrasonic cleaner to obtain the gradient wettability tool. Operating parameters of the optical fiber laser marking machine included: a laser wavelength of 1060 nm, and a laser power of 5 W. An area of the lyophilic micro-texture accounted for 15% of a total area of the lyophobic layer. The lyophilic micro-texture included main trapezoid grooves, a wide end of which was arranged in a tool-chip interface of the tool with a distance of 50 μm from a midpoint of the wide end of the groove to a cutting edge of the tool, and inward-radiated trapezoid microgrooves, a wide end of which was connected to a narrow end of the main trapezoid groove. The main trapezoid grooves were arranged with a pitch of 2 mm. A wedge angle of the single main trapezoid groove was 5 degrees. A depth of the single main trapezoid groove was 30 μm. A length was 8 mm, and a length of a narrow end of the main trapezoid groove was 2 mm. A width was 0.5 mm, and an angle between the single main trapezoid groove and an outflow direction of the chips was 30 degrees. A wedge angle of the inward-radiated trapezoid microgroove was 5 degrees. A depth was 30 μm. A length was 2 mm. A width was 0.2 mm. An angle between the inward-radiated trapezoid microgroove and the main trapezoid groove was 60 degrees. There were 25 inward-radiated trapezoid microgrooves connected to the single main trapezoid groove.

The tool fabricated in Example 1 was then performance tested as follows:

A cutting fluid was dropwise added to a cutting fluid receiving area of the surface of the tool by using an injector which was positioned vertically with respect to the surface, as shown in FIG. 5(a). After 5 ms, the cutting fluid was quickly collected into the narrow ends of the main trapezoid grooves by virtue of the inward-radiated trapezoid microgrooves, as shown in FIG. 5(b). After 8 ms, the cutting fluid was quickly transported to a position at a distance of 2 mm from the narrow ends of the main trapezoid grooves, as shown in FIG. 5(c). After 10 ms, the cutting fluid was transported to a position at a distance of 6 mm from the narrow ends of the main trapezoid grooves, as shown in FIG. 5(d). After 13 ms, the cutting fluid was transported to the narrow ends, namely the tool-chip interfaces, of the main trapezoid grooves, as shown in FIG. 5(e). Therefore, as seen from FIG. 5, by virtue of the inward-radiated trapezoid microgrooves and the main trapezoid grooves, the cutting fluid was directionally transported from the cutting fluid receiving areas to the tool-chip interfaces, which indicated that the gradient wettability tool had an excellent cutting fluid transport capability.

Preferable embodiments of the present invention have been described in detail. It should be noted that various improvements and modifications can be made by those skilled in the art without departing from the principle of the present invention and shall fall within the scope of the claimed invention.

What is claimed is:

1. A gradient wettability tool, comprising:
a tool body; and
a lyophobic layer arranged on a surface of the tool body, wherein:
a lyophilic micro-texture is arranged on a part of a surface of the lyophobic layer,
the lyophilic micro-texture comprises main trapezoid grooves and inward-radiated trapezoid microgrooves,
a wide end of each of the main trapezoid grooves is arranged in a tool-chip interface of the gradient wettability tool with a distance of 1 to 200 μm from a midpoint of the wide end of each of the main trapezoid grooves to a cutting edge of the gradient wettability tool, and
a wide end of each of the inward-radiated trapezoid microgrooves is arranged to be connected to a narrow end of one of the main trapezoid grooves.

2. The gradient wettability tool according to claim 1, wherein an area of the lyophilic micro-texture accounts for 5 to 50% of a total area of the lyophobic layer.

3. The gradient wettability tool according to claim 1, wherein an angle between the inward-radiated trapezoid microgrooves and the main trapezoid grooves is less than or equal to 90 degrees.

4. The gradient wettability tool according to claim 1, wherein the main trapezoid grooves are arranged such that any two grooves of the main trapezoid grooves are spaced 2 μm to 6 mm apart from each other.

5. The gradient wettability tool according to claim 2, wherein the main trapezoid grooves are arranged such that any two grooves of the main trapezoid grooves are spaced 2 μm to 6 mm apart from each other.

6. The gradient wettability tool according to claim 3, wherein the main trapezoid grooves are arranged such that any two grooves of the main trapezoid grooves are spaced 2 μm to 6 mm apart from each other.

7. The gradient wettability tool according to claim 1, wherein:
each of the main trapezoid grooves has a wedge angle of 1 to 10 degrees, a depth of 1 to 100 μm, a length of 0.1 to 10 mm, and a width of 1 μm to 3 mm, and an angle between each of the main trapezoid grooves and an outflow direction of chips is 5 to 175 degrees.

8. The gradient wettability tool according to claim 1, wherein each of the inward-radiated trapezoid microgrooves has a wedge angle of 1 to 10 degrees, a depth of 1 to 100 μm, a length of 0.1 to 5 mm, and a width of 1 μm to 3 mm.

9. The gradient wettability tool according to claim 2, wherein each of the inward-radiated trapezoid microgrooves has a wedge angle of 1 to 10 degrees, a depth of 1 to 100 μm, a length of 0.1 to 5 mm, and a width of 1 μm to 3 mm.

10. The gradient wettability tool according to claim 3, wherein each of the inward-radiated trapezoid microgrooves has a wedge angle of 1 to 10 degrees, a depth of 1 to 100 μm, a length of 0.1 to 5 mm, and a width of 1 μm to 3 mm

11. The gradient wettability tool according to claim 7, wherein each of the inward-radiated trapezoid microgrooves has a wedge angle of 1 to 10 degrees, a depth of 1 to 100 μm, a length of 0.1 to 5 mm, and a width of 1 μm to 3 mm.

12. A process for fabricating a gradient wettability tool, comprising steps of:
fabricating a lyophobic layer on a surface of a tool body; and
forming a lyophilic micro-texture on a part of a surface of the lyophobic layer to obtain the gradient wettability tool, wherein:
the lyophilic micro-texture comprises main trapezoid grooves and inward-radiated trapezoid microgrooves,
a wide end of each of the main trapezoid grooves is arranged in a tool-chip interface of the gradient wettability tool with a distance of 1 to 200 μm from a midpoint of the wide end of each of the main trapezoid grooves to a cutting edge of the gradient wettability tool, and
a wide end of each of the inward-radiated trapezoid microgrooves is arranged to be connected to a narrow end of one of the main trapezoid grooves.

13. The process according to claim 12, wherein:
a method for forming the lyophilic micro-texture comprises a laser processing method, and
operating conditions of the laser processing method comprise a laser wavelength of 1060 nm and a laser power of 5 to 30W.

14. A process for using a gradient wettability tool in a high-speed cutting process or a hard-to-machine material cutting process, comprising a step of:
providing a gradient wettability tool comprising a tool body and a lyophobic layer arranged on a surface of the tool body, wherein:
a lyophilic micro-texture is arranged on a part of a surface of the lyophobic layer,
the lyophilic micro-texture comprises main trapezoid grooves and inward-radiated trapezoid microgrooves,
a wide end of each of the main trapezoid grooves is arranged in a tool-chip interface of the gradient wettability tool with a distance of 1 to 200 um from a midpoint of the wide end of each of the main trapezoid grooves to a cutting edge of the gradient wettability tool, and
a wide end of each of the inward-radiated trapezoid microgrooves is arranged to be connected to a narrow end of one of the main trapezoid grooves.
